(19) United States
(12) Patent Application Publication
(10) Pub. No.: US 2012/0026375 A1
(43) Pub. Date: Feb. 2, 2012

(54) Method and Apparatus For a Projector and Camera System

(75) Inventors: Jani Petteri Vare, Kaarina (FI); Jyrki Alamaunu, Turku (FI)

(73) Assignee: Nokia Corporation

(21) Appl. No.: 12/844,430

(22) Filed: Jul. 27, 2010

(51) Int. Cl. H04N 5/222; H04N 9/74

(52) U.S. Cl. 348/333.1; 348/E05.022; 348/584; 348/E09.055; 348/E09.025

(57) ABSTRACT

In accordance with an example embodiment of the present invention, an apparatus is disclosed. The apparatus includes a projector and a camera. The projector is configured to project a first moving picture. The camera configured to capture a combined moving picture. The combined moving picture includes the projected first moving picture and a second moving picture displayed from another device. The apparatus is configured to perform an action based upon the combined moving picture.

### TECHNICAL FIELD

The present application relates generally to a projector and camera system.

### BACKGROUND

Interest in various hand held projector technologies has increased over the last several years. As electronic devices continue to become more sophisticated, these devices provide an increasing amount of functionality by including such applications as, for example, a mobile phone, digital camera, video camera, navigation system, gaming capabilities, and internet browser applications.

Accordingly, as consumers demand increased functionality from electronic devices, there is a need to provide improved devices having increased capabilities, such as projector capabilities, while maintaining robust and reliable product configurations.

### SUMMARY

Various aspects of examples of the invention are set out in the claims.

According to a first aspect of the present invention, an apparatus is disclosed. The apparatus includes a projector and a camera. The projector is configured to project a first moving picture. The camera configured to capture a combined moving picture. The combined moving picture includes the projected first moving picture and a second moving picture displayed from another device. The apparatus is configured to perform an action based upon the combined moving picture.

According to a second aspect of the present invention, an apparatus is disclosed. The apparatus includes at least one processor and at least one memory. The at least one memory includes computer program code. The at least one memory and the computer program code configured to, with the at least one processor, cause the apparatus to perform at least the following. Process a combined moving picture. The combined moving picture includes a first moving picture and a second moving picture. The first moving picture is projected from a first projector. The second moving picture is projected from a second projector. Provide a first indication based on the combined moving picture.

According to a third aspect of the present invention, a method is disclosed. A first moving picture is projected from a first projector. A second moving picture is projected from a second projector. A combined moving picture is captured with a camera. The combined moving picture includes the first moving picture and the second moving picture. An action is performed based on the combined moving picture.

According to a fourth aspect of the present invention, a computer program product having a computer-readable medium bearing computer program code embodied therein for use with a computer, is disclosed. Code for capturing a combined moving picture with a camera. The combined moving picture includes a first moving picture and a second moving picture. The first moving picture is projected from a first projector. The second moving picture is projected from a second projector. Code for providing an indication based on the captured combined moving picture.

### BRIEF DESCRIPTION OF THE DRAWINGS

For a more complete understanding of example embodiments of the present invention, reference is now made to the following descriptions taken in connection with the accompanying drawings in which:

FIG. 1 is a diagram of an interactive projector based system incorporating features of the invention;

FIG. 2 is a front view of an electronic device shown in FIG. 1;

FIG. 3 is a rear view of the electronic device shown in FIG. 2;

FIG. 4 is a top plan view of the electronic device shown in FIG. 2;

FIG. 5 is a diagram of another example of an interactive projector based system incorporating features of the invention;

FIG. 6 is a diagram of another example of an interactive projector based system incorporating features of the invention;

FIG. 7 is a diagram of another example of an interactive projector based system incorporating features of the invention;

FIG. 8 is a block diagram of an exemplary method of the system shown in FIG. 1; and

FIG. 9 is a schematic drawing illustrating components of the electronic device shown in FIG. 1.

### DETAILED DESCRIPTION OF THE DRAWINGS

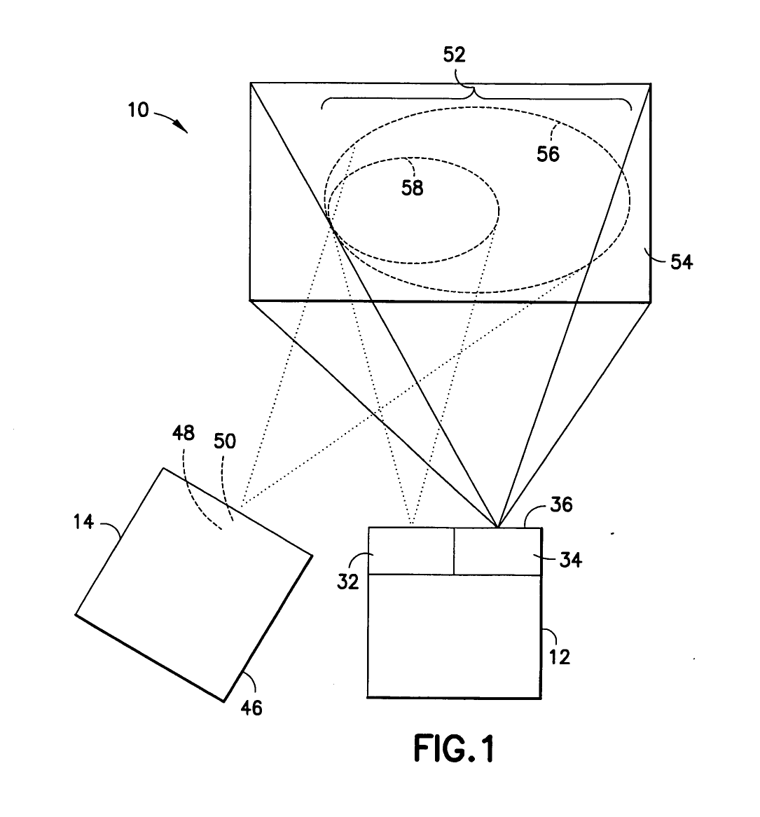

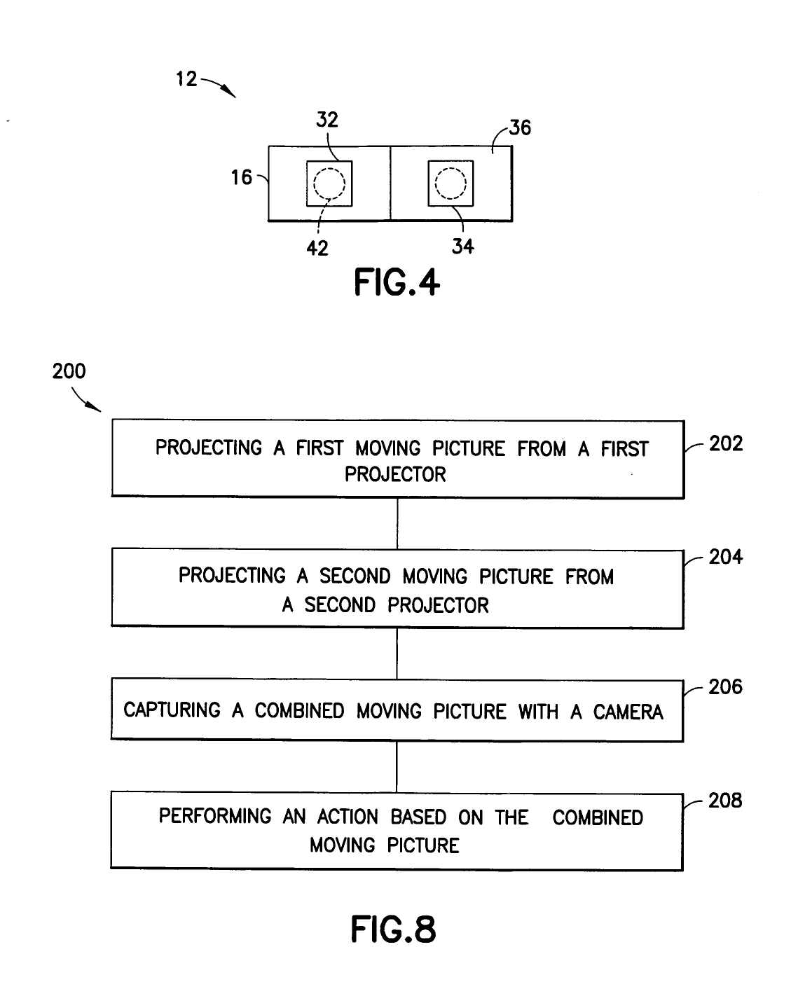

An example embodiment of the present invention and its potential advantages are understood by referring to FIGS. 1 through 9 of the drawings.

Referring to FIG. 1, there is shown a perspective view of an interactive projector based system 10 incorporating features of the invention. Although the invention will be described with reference to the exemplary embodiments shown in the drawings, it should be understood that the invention can be embodied in many alternate forms of embodiments. In addition, any suitable size, shape or type of elements or materials could be used.

The interactive projector based system 10 comprises an electronic device 12 and a system projector unit 14. The interactive projector based system 10 provides for integrating moving pictures (or videos) from two different devices.

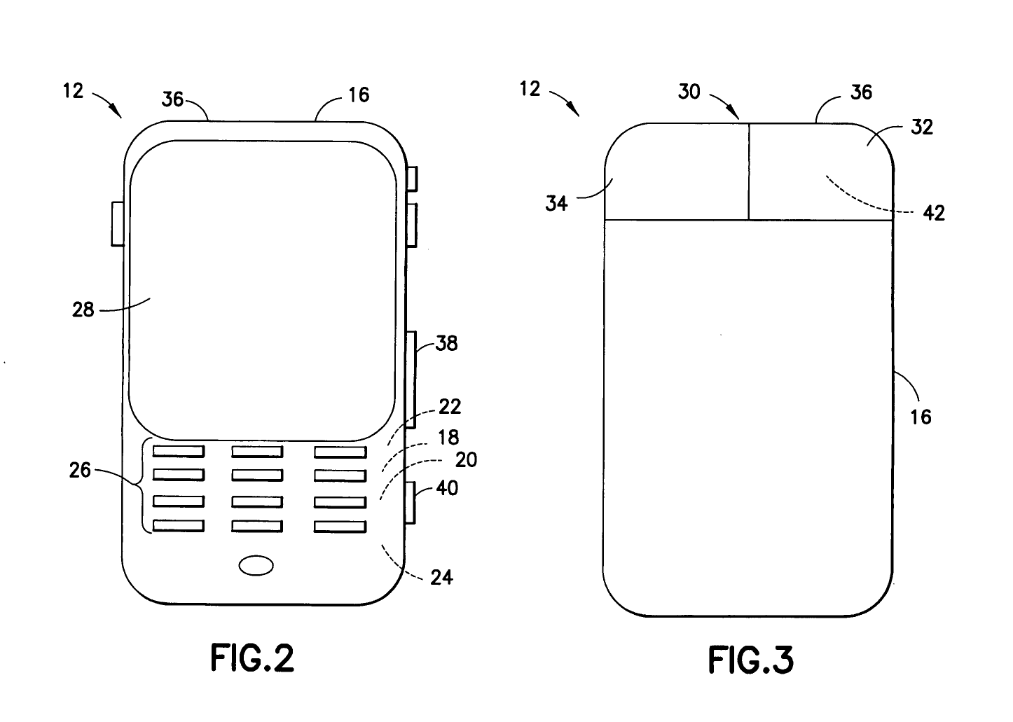

Referring now also to FIGS. 2-4, the device 12 is a multi-function portable electronic device. However, in alternate embodiments, features of the various embodiments of the invention could be used in any suitable type of portable electronic device such as a mobile phone, a gaming device, a music player, a notebook computer, or a personal digital assistant, for example. In addition, as is known in the art, the device 12 can include multiple features or applications such as a music player, a game player, or an Internet browser, for example. The device 12 generally comprises a housing 16, a transmitter 18, a receiver 20, an antenna 22 (connected to the transmitter 18 and the receiver 20), electronic circuitry 24, such as a controller (which could include a processor for example) and a memory for example, within the housing 16, a user input region 26 and a display 28. The display 28 could also form a user input section, such as a touch screen. It should be noted that in alternate embodiments, the device 12 can have any suitable type of features as known in the art.

The electronic device 12 further comprises an image integration system 30. The image integration system 30 comprises a projector 32 and a camera 34. The projector 32 and the camera 34 are shown as being adjacently disposed proximate a top end 36 of the device 12, but may alternatively or additionally be disposed in any suitable location or fashion. The projector 32 and the camera 34 may be controlled by actuators 38, 40. However, any suitable projector/camera control functions or projector/camera user inputs may be provided.

The projector 32 may be suitably disposed at the top end 36 of the device 12 such that a lens 42 of the projector 32 is proximate the top end 36. However, in alternate embodiments, any suitable projector (or projector lens) location or orientation may be provided. Additionally, the projector 32 can have any suitable type of features as known in the art. The projector 32 is configured to project an image, such as a moving picture (or video), on to a screen, or any display surface suitably sized and shaped for projection purposes such as a wall or table/desk top for example.

The camera 34 may be suitably disposed at the top end 36 of the device 12 such that a lens 44 of the camera 34 is proximate the top end 36. However, in alternate embodiments, any suitable camera (or camera lens) location or orientation may be provided. Additionally, the camera 34 can have any suitable type of features as known in the art. The camera 34 comprises a video camera configured to capture a motion picture. For example, according to various exemplary embodiments of the invention, the camera 34 is configured to capture a combined motion picture comprising motion pictures from more than one source (such as more than one projector, for example).

While various exemplary embodiments of the invention are described in connection with the device having one projector and one camera, one skilled in the art will appreciate that the various embodiments are not necessarily so limited and that any suitable number of projectors and/or cameras may be provided within the device.

The system projector unit 14 may be a separate standalone unit comprising a housing 46 and a projector 48. However, in alternate embodiments the system projector unit may be provided in any other suitable type of device. The projector 48 may suitably disposed at an end of the housing 46 such that a lens 50 of the projector 48 may be aligned for projecting images. Additionally, the projector 48 can have any suitable type of features as known in the art. The projector 48 is configured to project an image, such as a moving picture (or video), on to a screen, or any display surface suitably sized and shaped for projection purposes such as a wall or table top for example.

While various exemplary embodiments of the invention are described in connection with one system projector unit, one skilled in the art will appreciate that the various embodiments are not necessarily so limited and that any suitable number of projectors may be provided in the interactive projector based system.

According to various exemplary embodiments of the invention, the interactive projector based system 10 provides for an end user to integrate a moving picture projected from a handheld device (such as the device 12) into a moving picture displayed onto a screen (or display surface/area) from another source, such as the system projector unit 14, for example.

FIG. 1 illustrates a combined moving picture (or combined moving image) 52 displayed on a screen (or display area/surface) 54. The combined moving picture 52 comprises a moving picture 56 projected from the projector 48 of the system projector unit 14 and a moving picture 58 projected from the projector 32 of the device 12. This provides for the moving picture 56 to form a portion of the combined moving picture 52, and for the moving picture 58 to form another portion of the combined moving picture 52. For example, the moving picture 58 may be on top of, or superimposed over, the moving picture 56 to form the combined moving picture (or superimposed image/view) 52, however in alternate embodiments, any suitable order or arrangement of the moving pictures to form the combined moving picture may be provided.

The device 12 is configured to capture the combined moving picture 52 with the video camera 34. The device 12 is further configured to process the captured combined image 52. For example, the processor and the memory of the device 12 are configured to cause the device 12 (or the system 10) to perform an action based on the captured combined moving picture 52.

According to one example of the invention, the moving picture 56 could be, for example, a road or race track and the moving picture 58 could be a vehicle controlled by the device 12. This would provide for a system of combined moving pictures which could be a racing game, for example, where the street is displayed on the screen 54 and the end user with the handheld device 12 displays the vehicle and operates the vehicle in the combined display 52. The car or vehicle projected from the handheld device 12 can be controlled with the handheld device 12 (such as by user input, or movement of the device 12, for example).

According to some embodiments of the invention a user score (based on the interaction between the moving picture 58 and the moving picture 56) in the game could be determined in the handheld device 12. For example, when the user operates the vehicle (projected by the device 12) on the track or road (projected by the system projector unit 14) the score could be accumulated by processing the combined image 52 to determine if the vehicle stays on the correct side of the road, or stays in a specified lane, or other predetermined criteria. In this example embodiment, the action performed could be determining the accumulated score.

Additionally, according to some embodiments of the invention, the running score could be displayed on the device 12 or on the display area 54. For example, the user device 12 could project a moving picture including the vehicle and the running score. In this example embodiment, the action performed could be providing an indication (such as the running score) based on the combined moving picture 52.

Referring now also to FIG. 5, the running score (based on the interaction between the moving picture 58 and the moving picture 56) could be determined on a server 60. The server 60 could be connected to the device by a link 62. The link 62 may be a wireless link for example, providing a connection to a local network, the internet, or a wireless communications network, for example. However, any suitable link may be provided. The server 60 may further comprise a processor and a memory, for example. Similar to the embodiment above, the running score could be displayed on the device 12 or on the display area 54. For example, the user device 12 could project a moving picture including the vehicle and the running score. In this example embodiment, the action performed by the server 60 could be providing an indication (such as the running score) based on the combined moving picture 52.

According to various exemplary embodiments of the invention, the processor and memory (of the device 12 and/or server 60) are configured to process the captured combined moving picture 52 to perform an action. For example, the interaction of the moving picture 58 with the moving picture 56 (such as projecting the car/vehicle and maintaining the car/vehicle within a lane or road) provides for the score to be tabulated. As such, the score could be a result of the interaction of the two moving pictures 56, 58, for example the score could be based on how long the vehicle is maintained on the road or lane, which is based on the processing of the two moving pictures 56, 58.

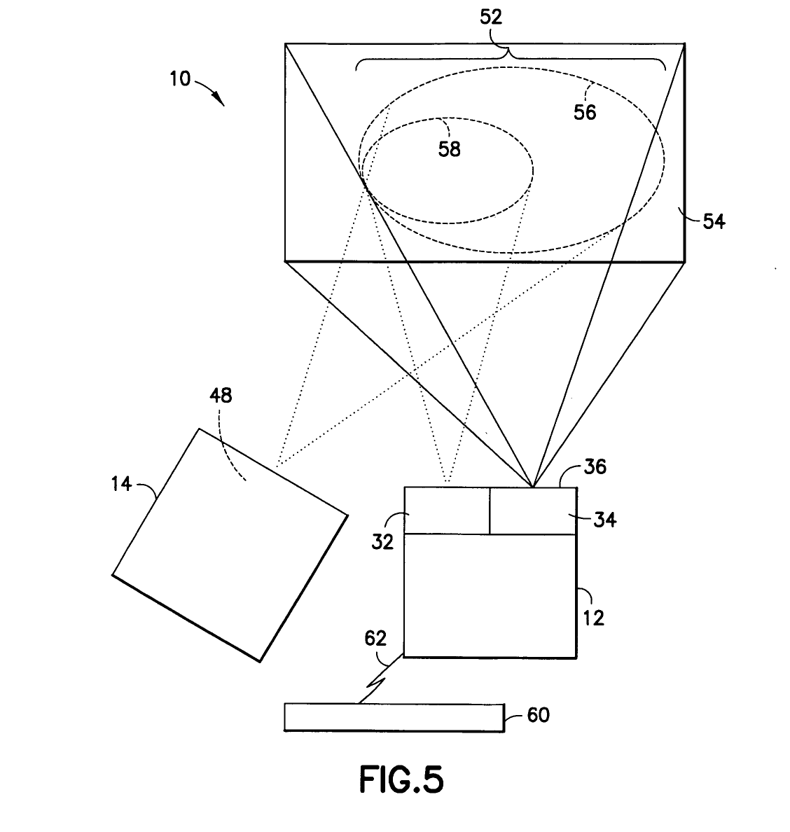

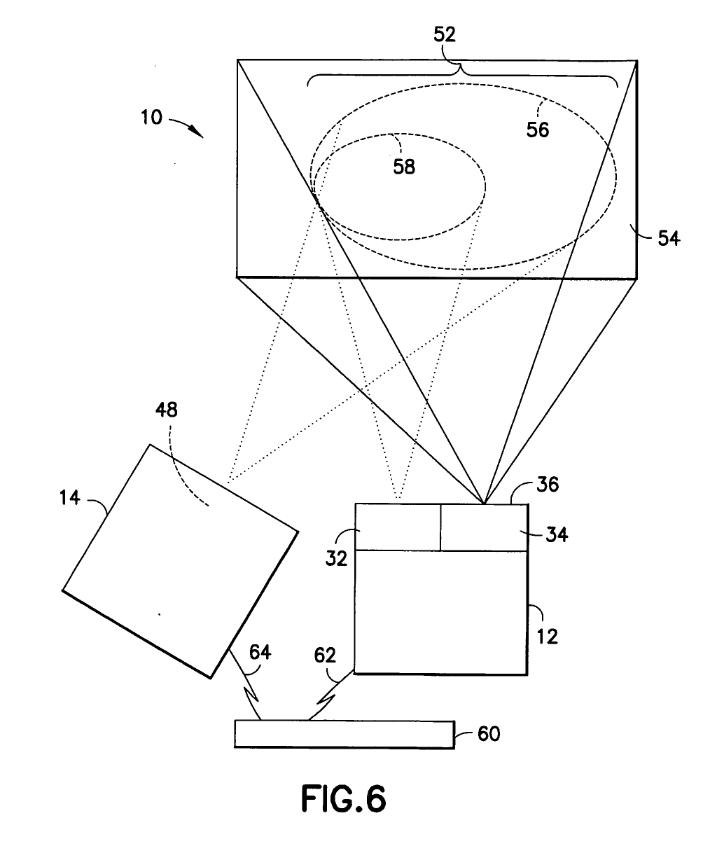

Referring now also to FIG. 6, according to some embodiments of the invention, the server 60 may also be connected to the system projector unit 14 by a link 64. The link 64 may be a wireless link for example, providing a connection to a local network, the internet, or a wireless communications network, for example. However, any suitable link may be provided. With the server 60 linked to the device 12 and the system projector unit 14, further interactions between the moving pictures 58, 56 may be provided. For example, in some embodiments of the invention, the device 12 and/or server 60 may process the combined image 52 and cause the projector 48 of the system projector unit 14 to display a change in the moving picture 56 based on the moving picture 58. For example, the running score may be displayed at a portion (such as along the top or bottom of the image, for example) of the moving picture 56 such that the running score is updated in real time.

According to some embodiments of the invention, with the server 60 linked to the device 12 and the system projector unit 14, the device 12 and/or server 60 may process the combined image 52 and cause the projector 48 of the system projector unit 14 to display a change in the street view or road layout based on whether the user of the device 12 turns the vehicle left or right, or if the user chooses a certain path when presented with an option of paths, or if the user drives the vehicle off the displayed road, or any other suitable option which may be taken by the user of the device 12. For example, while the camera 34 captures the combined image 52, if the user moves the vehicle to turn left or right, the server 60 can process this change and cause the projector 48 of the system projector unit 14 to project an updated view of the road/track based on the change in the moving picture 58. This provides for the moving picture 56 to be interactive with the moving picture 58 (such as in real time, for example), such that indications or changes in at least one of the displayed moving pictures 56, 58 may be provided based on the interaction between the moving pictures 56, 58.

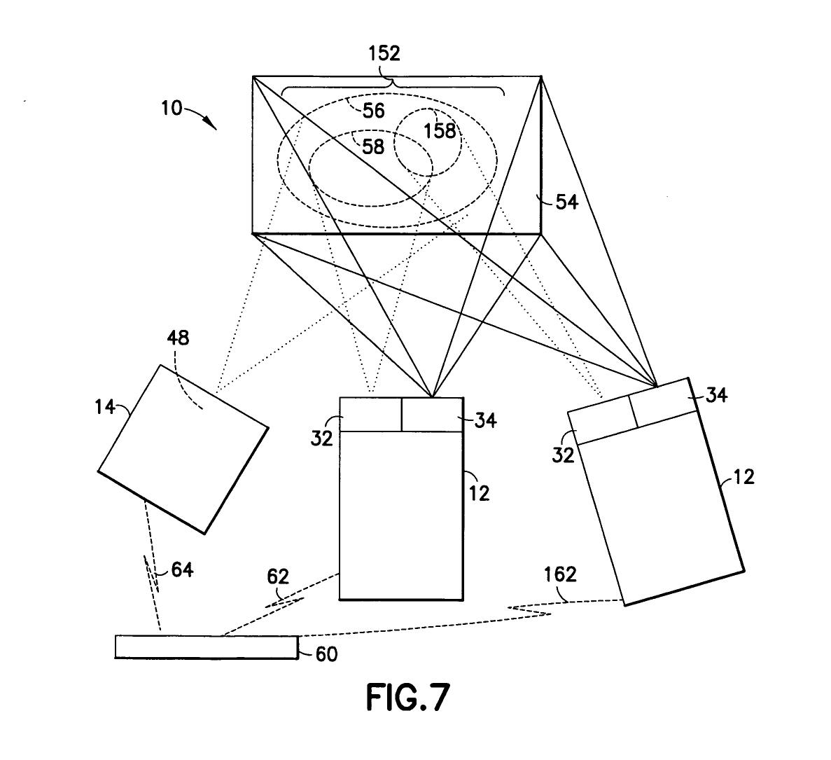

Referring now also to FIG. 7, according to some embodiments of the invention the image integration system 30 may be configured to allow for more than one user to interact with the interactive projector based system 10, such that two (or more) users with handheld devices equipped with the image integration system (having a projector and a camera) provide moving pictures to form the combined moving picture.

Similar to the embodiments shown in FIGS. 1, 5, 6, FIG. 7 illustrates a combined moving picture (or combined moving image) 152 displayed on the screen (or display area/surface) 54. The combined moving picture 152 comprises the moving picture 56 projected from the projector 48 of the system projector unit 14 and the moving picture 58 projected from the projector 32 of the device 12. In addition, the combined moving picture 152 comprises a moving picture 158 projected from the projector 32 of another device 12. This provides for the moving picture 56 to form a portion of the combined moving picture 152, for the moving picture 58 to form a portion of the combined moving picture 152, and for the moving picture 158 to form another portion of the combined moving picture 152. For example, the moving pictures 58, 158 may be on top of, or superimposed over, the moving picture 56 to form the combined moving picture (or superimposed image/view) 152, however in alternate embodiments, any suitable order or arrangement of the moving pictures to form the combined moving picture may be provided.

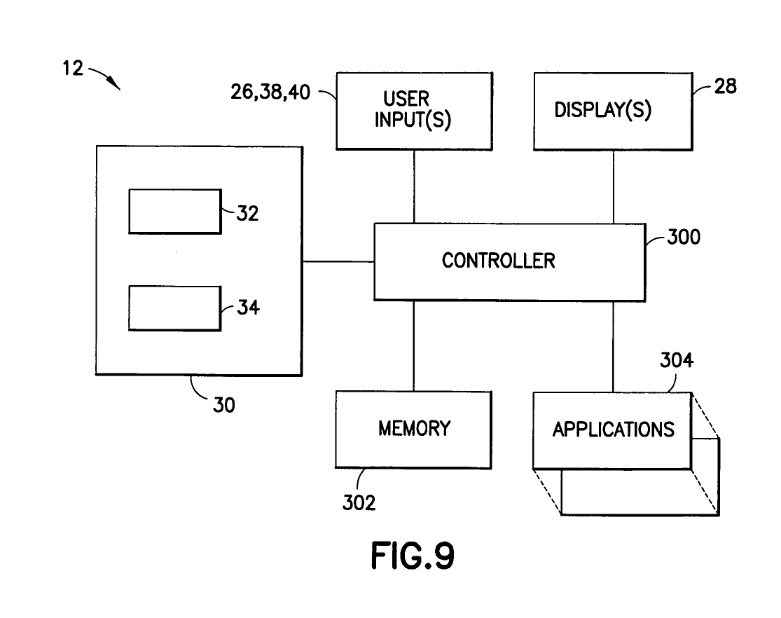

Similar to the embodiments shown in FIGS. 1, 5, 6, the two devices 12 may project moving pictures 58, 158 in the form of vehicles, for example, to simultaneously play the racing game, and capture the combined moving pictures 56, 58, 158 with the device cameras 34. Also similar to the embodiments above, the device 12 and/or server 60 (which may be connected by links 62, 64, 162 to the devices 12 and/or the system projector unit 14) processes the captured combined moving picture 152 to perform an action based on the combined moving image 152, wherein the action may be, for example, providing a running score (on the device and/or on a portion of the combined moving picture 152) or changing the projected image 56 based on the moving pictures 58, 158. In addition, any other suitable functionality described above for the embodiments shown in FIGS. 1, 5, 6, may be provided in the multi-player embodiment shown in FIG. 9.

FIG. 8 illustrates a method 200. The method 200 includes projecting a first moving picture from a first projector (at block 202). Projecting a second moving picture from a second projector (at block 204). Capturing a combined moving picture with a camera, wherein the combined moving picture comprises the first moving picture and the second moving picture (at block 206). Performing an action based on the combined moving picture (at block 208). It should be noted that the illustration of a particular order of the blocks does not necessarily imply that there is a required or preferred order for the blocks and the order and arrangement of the blocks may be varied. Furthermore it may be possible for some blocks to be omitted.

Referring now also to FIG. 9, the device 12 generally comprises a controller 300 such as a microprocessor for example. The electronic circuitry includes a memory 302 coupled to the controller 300, such as on a printed circuit board for example. The memory could include multiple memories including removable memory modules for example. The device has applications 304, such as software, which the user can use. The applications can include, for example, a telephone application, an Internet browsing application, a game playing application, a digital camera application, a video camera application, a video projector application, a map/gps application, etc. These are only some examples and should not be considered as limiting. One or more user inputs 26, 38, 40 are coupled to the controller 300 and one or more displays 28 are coupled to the controller 300. The image integration system 30 is also coupled to the controller 300. The device 12 may programmed to automatically perform actions based on the captured combined moving picture. However, in an alternate embodiment, this might not be automatic.

It should be understood that although various exemplary embodiments of the invention have been described in connection with a racing game, any other suitable type of games or interactive functionality may be provided. For example, some further non-limiting examples may include stationary tablets (such as large wall paintings or alike) where the user can beam (or project) his/her data thereto, modelling contests (such that given a task, the user makes the model in his/her device, such as a structure, or a dress-up, for example, and “beams” [or projects] it up when the whistle blows [or timer ends]), BUZZ-like games, or chess, for example. The game may be service-based in cases where the complexity over-exceeds the end device capabilities, such as in chess where the user selects the piece to move by keypad but the camera-projector combination is controlled by the service so that the beamed image matches the selection and matches the piece on the board. Then when the piece is to be moved, the user moves the end device according to the move. The camera-projector combination may then control the even movement on the table.

While various exemplary embodiments of the invention have been described in connection with the camera as being installed in the electronic device, one skilled in the art will appreciate that the various exemplary embodiments are not necessarily so limited and that the camera may be provided at an external location other than the device. For example, in some embodiments, the camera 34 may be provided with the system projector unit 14. In other embodiments, the camera 34 may be provided as a standalone unit.

It should further be understood that the term “interaction” may be any suitable interaction allowing for change in score, change in projected image, or any other suitable change. For example, the “interaction” may be based on position, location, duration, of the projected moving pictures. Additionally, the interaction between the moving pictures (or the moving pictures being interactive with each other) may comprise a position of one of the moving pictures relative to the position of another moving picture.

Without in any way limiting the scope, interpretation, or application of the claims appearing below, a technical effect of one or more of the example embodiments disclosed herein is providing for several projectors to “beam” (or project) moving images to the screen (or display area), wherein the final content (or combined moving picture/image) is the sum of all the separate “beams” (or projected images). Another technical effect of one or more of the example embodiments disclosed herein is providing for combining moving images and forming, for example, a game from the combined moving images. Another technical effect of one or more of the example embodiments disclosed herein is providing a novel system of combining moving pictures from several sources into an interactive gaming experience. Another technical effect of one or more of the example embodiments disclosed herein is providing the interaction as a multi-user interaction which is audience friendly. Conventional configurations, on the other hand, generally provide for either one-user based or non-interactive configurations.

According to one example of the invention, an apparatus is disclosed. The apparatus includes a projector and a camera. The projector is configured to project a first moving picture. The camera is configured to capture a combined moving picture. The combined moving picture comprises the projected first moving picture and a second moving picture displayed from another device. The apparatus is configured to perform an action based upon the combined moving picture.

According to one example of the invention, an apparatus is disclosed. The apparatus includes at least one processor and at least one memory including computer program code. The at least one memory and the computer program code configured to, with the at least one processor, cause the apparatus to perform at least the following: process a combined moving picture. The combined moving picture comprises a first moving picture and a second moving picture. The first moving picture is projected from a first projector. The second moving picture is projected from a second projector. Provide a first indication based on the combined moving picture.

According to another example of the invention, a program storage device readable by a machine, tangibly embodying a program of instructions executable by the machine for performing operations to perform an action based on a combined moving picture. Code for capturing a combined moving picture with a camera. The combined moving picture comprises a first moving picture and a second moving picture. The first moving picture is projected from a first projector. The second moving picture projected from a second projector. Code for providing an indication based on the captured combined moving picture.

It should be understood that components of the invention can be operationally coupled or connected and that any number or combination of intervening elements can exist (including no intervening elements). The connections can be direct or indirect and additionally there can merely be a functional relationship between components.

It should be understood that the projected and captured moving pictures described in connection with the various exemplary embodiments of the invention are provided as a non-limiting example and may comprise any type of motion picture image, video, animation, computer generated image, or any other suitable type of image.

As used in this application, the term ‘circuitry’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Embodiments of the present invention may be implemented in software, hardware, application logic or a combination of software, hardware and application logic. The software, application logic and/or hardware may reside on the system 10, the electronic device 12, or the server 60. If desired, part of the software, application logic and/or hardware may reside on the system 10, part of the software, application logic and/or hardware may reside on the device 12, and part of the software, application logic and/or hardware may reside on the server 60. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 9. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus, comprising:
a projector configured to project a first moving picture; and
a camera configured to capture a combined moving picture, wherein the combined moving picture comprises the projected first moving picture and a second moving picture displayed from another device, and wherein the apparatus is configured to perform an action based upon the combined moving picture.

2. An apparatus as in claim 1 wherein the second moving picture is projected from another different projector.

3. An apparatus as in claim 1 wherein the first moving picture is configured to be interactive with the second moving picture.

4. An apparatus as in claim 1 wherein the apparatus is configured to display a change in the second moving picture based on, at least in part, the projected first moving picture.

5. An apparatus as in claim 1 wherein the combined moving picture comprises the projected first moving picture, the second moving picture, and a third moving picture displayed from another different device, and wherein the apparatus is configured to perform an action based upon the combined moving picture.

6. An apparatus as in claim 1 wherein the apparatus comprises a mobile phone.

7. A system comprising:
a system projector; and
an apparatus as in claim 1, wherein the another device comprises the system projector.

8. An apparatus, comprising:
at least one processor; and
at least one memory including computer program code
the at least one memory and the computer program code configured to, with the at least one processor, cause the apparatus to perform at least the following:
process a combined moving picture, wherein the combined moving picture comprises a first moving picture and a second moving picture, wherein the first moving picture is projected from a first projector, and wherein the second moving picture is projected from a second projector; and
provide a first indication based on the combined moving picture.

9. An apparatus as in claim 8 wherein the at least one memory and the computer program code configured to, with the at least one processor, cause the apparatus to further perform at least the following:
provide a change in the second moving picture based on, at least in part, the projected first moving picture.

10. An apparatus as in claim 8 wherein the at least one memory and the computer program code configured to, with the at least one processor, cause the apparatus to further perform at least the following:
provide a first indication based on an interaction between the first moving picture and the second moving picture.

11. An apparatus as in claim 8 wherein the combined moving picture comprises the first moving picture, the second moving picture, and a third moving picture, wherein the third moving picture is projected from a third projector.

12. An apparatus as in claim 8 wherein the apparatus comprises a mobile phone.

13. An apparatus as in claim 8 wherein the apparatus comprises a server.

14. A method, comprising:
projecting a first moving picture from a first projector;
projecting a second moving picture from a second projector;
capturing a combined moving picture with a camera, wherein the combined moving picture comprises the first moving picture and the second moving picture; and
performing an action based on the combined moving picture.

15. A method as in claim 14 further comprising processing the combined moving picture with a processor.

16. A method as in claim 14 further comprising displaying a change in the second moving picture based on, at least in part, the projected first moving picture.

17. A method as in claim 14 further comprising providing a first indication based on an interaction between the first moving picture and the second moving picture.

18. A method as in claim 14 further comprising projecting a third moving picture from a third projector.

19. A computer program product comprising a computer-readable medium bearing computer program code embodied therein for use with a computer, the computer program code comprising:
code for capturing a combined moving picture with a camera, wherein the combined moving picture comprises a first moving picture and a second moving picture, wherein the first moving picture is projected from a first projector, and wherein the second moving picture projected from a second projector; and
code for providing an indication based on the captured combined moving picture.

20. A computer program product as in claim 19 further comprising code for displaying a change in the second moving picture based on, at least in part, the projected first moving picture.

21. A computer program product as in claim 19 wherein the code for providing the indication further comprises code for providing an indication based on an interaction between the first moving picture and the second moving picture.
